(19) United States
(12) Patent Application Publication
(10) Pub. No.: US 2006/0259658 A1
(43) Pub. Date: Nov. 16, 2006

(54) DMA reordering for DCA

(76) Inventors: Patrick L. Connor, Portland, OR (US); Linden Cornett, Portland, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/129,559

(22) Filed: May 13, 2005

(51) Int. Cl. G06F 13/28; G06F 12/00

(52) U.S. Cl. 710/22; 711/118

(57) ABSTRACT

In an embodiment, an apparatus and method include reordering direct cache access (DCA) and non-DCA transfers so that DCA transfers are last transactions and therefore closer to an interrupt than non-DCA transfers. Embodiments also include coordinating with interrupt processing DCA requests for DCA and non-DCA transfers.

### TECHNICAL FIELD

Embodiments of the present apparatus and method relate in general to direct cache access, and, in particular, to cache management.

### BACKGROUND

When improving high-speed network performance, one hurdle is memory access latency. Cache misses are one cause of latency. A cache miss occurs when data requested by a processor is not in the processor's cache memory, and must be accessed from a slower memory device.

Cache misses are reduced with cache warming. Cache warming is a technology to place data into a processor's cache before the processor attempts to access it. Currently, there are two relevant methods of cache warming data. The first method is to issue processor pre-fetch commands for source and/or destination addresses before they are accessed. The second method is to use Direct Cache Access (DCA). With DCA, special tags are included in bus transactions to indicate that this data is to be placed into a given processor's cache as the data is transferred to memory.

Unfortunately, both of these methods have drawbacks when utilized in high-speed network applications such as 10 gigabit Ethernet. There is a need for improved methods of managing cache memory.

### BRIEF DESCRIPTION OF THE DRAWINGS

Embodiments of the present inventive subject matter may be best understood by referring to the following description and accompanying drawings, which illustrate such embodiments. In the drawings:

FIG. 1 depicts an embodiment of the present subject matter for use in DMA reordering;

FIG. 2 depicts transfer of a packet according to an embodiment of the present subject matter;

FIG. 3 depicts transfer of packets according to another embodiment of the present subject matter;

FIG. 4 is a flow diagram of a method for Direct Memory Access (DMA) according to an embodiment of the present subject matter;

FIG. 5 is a flow diagram of a method for DMA according to another embodiment of the present subject matter;

FIG. 6 is a flow diagram of a method for DMA according to another embodiment of the present subject matter; and

FIG. 7 is a flow diagram of a method for DMA according to another embodiment of the present subject matter.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Such embodiments of the inventive subject matter may be referred to, individually and/or collectively, herein by the term “invention” merely for convenience and without intending to voluntarily limit the scope of this application to any single invention or inventive concept if more than one is in fact disclosed.

Direct Memory Access (DMA) is a method of transferring data from an input/output (I/O) device to a memory device without intervention by a central processing unit (CPU). A DMA controller (DMAC) behaves as a bus master on a bus carrying data to or from the I/O device and a memory device during DMA. Data transferred across a network, such as a network using Ethernet, is transferred in packets. Each packet typically contains a header and packet data. Packet descriptors are often used to convey status and other information about the packets (location, length, error status etc.) These packets and descriptors are DMA transferred across the bus as they move to and from a host system to an Ethernet controller.

According to embodiments of the present subject matter, some data transferred by DMA is also placed directly in a cache memory according to Direct Cache Access (DCA), while other data transferred by DMA is not placed in the cache memory according to DCA. DCA and non-DCA transfers are reordered to improve the management of the cache memory.

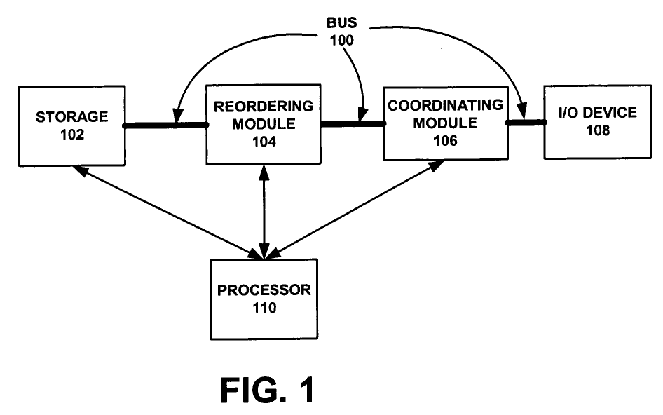

FIG. 1 depicts an embodiment of the present subject matter that implements DMA with reordering. A bus 100 may be operatively coupled to, for example, a storage device 102, a reordering module 104, a coordinating module 106, and an I/O device 108. The bus 100 may have bus-ordering rules. The storage device 102 may be a disk drive device, a DRAM, a Flash memory device, or an SRAM. The I/O device 108 may be a cable modem coupled to a network using Ethernet or an omni-directional antenna in a wireless network. A processor 110 may be operatively coupled to the storage device 102, the reordering module 104, and the coordinating module 106. The processor 110 controls operation of these elements for transfer of, for example, packets on the bus 100. Using the reordering module 104, DCA and non-DCA transfers on the bus 100 may be reordered such that DCA transfers are last transactions and therefore closer to an interrupt than non-DCA transfers. Using the coordinating module 106, requests for DCA and non-DCA transfers may be coordinated with interrupt processing by the processor 110. Other configurations of the system may utilize the present subject matter.

According to some embodiments of the present subject matter, only the headers and descriptors of packets that the processor 110 will initially access are placed in the cache memory according to DCA. In other embodiments of the present subject matter, the DCA data may be placed in the cache memory (cache warmed) immediately prior to access by the processor 110. This prevents early eviction of other cache contents and greatly increases the probability of the DCA data still being in cache when the processor 110 accesses it.

According to some embodiments of the present subject matter, DCA and non-DCA transfers are reordered so that DCA transfers are the last transactions and therefore closer to an interrupt. This reordering is independent from, and does not violate, the bus ordering rules. For example, when a received packet is transferred, the headers and the descriptors are generally DCA transactions and the packet data is not. Packets are not accessed until the descriptors are transferred, and so long as the descriptors remain the final transfer, the order of the other transfers can be changed.

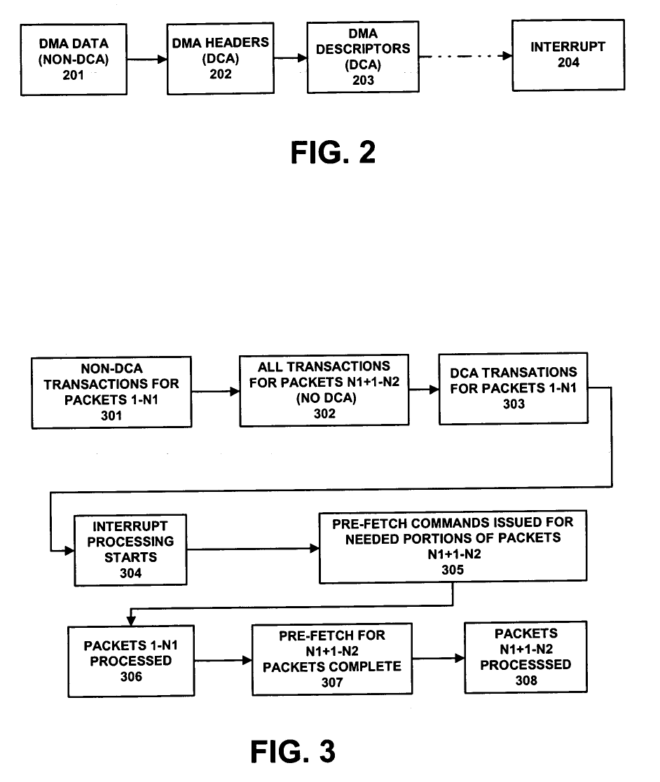

FIG. 2 depicts the transfer of a packet according to an embodiment of the present subject matter. DMA data is transferred in a non-DCA manner in 201. A DCA transfer of DMA headers occurs in 202, and a DCA transfer of DMA descriptors occurs in 203. An interrupt occurs in 204.

FIG. 3 depicts transfer of multiple packets according to an embodiment of the present subject matter. The transfers in FIG. 3. are coordinated with an interrupt assertion. This allows DCA transactions for multiple packets to be reordered. DCA transactions are issued for the first N1 packets in FIG. 3. For packets N1+1−N2 that are subsequent to N1, DCA transactions are not issued. The DCA transactions of packets 1−N1 are reordered so as to occur after the non-DCA transactions. This allows initial accesses of a driver's interrupt processing function to issue pre-fetch commands for needed components of packets N1+1−N2. This allows the pre-fetch operations to occur in the background while packets 1−N1 are processed.

In 301 of FIG. 3, non-DCA transactions for packets 1−N1 are implemented. In 302, all transactions for packets N1+1−N2 are implemented. None of the transactions for packets N1+1−N2 are DCA transactions. In 303, DCA transactions for packets 1−N1 are implemented, and interrupt processing starts in 304. In 305, pre-fetch commands are issued for needed portions of packets N1+1−N2. Packets 1−N1 are processed in 306. In 307, pre-fetch for packets N1+1−N2 is complete. In 308, packets N1+1−N2 are processed.

For improved performance, the value of N1 (how many packets to use DCA on) may be adaptively programmable. The value for N1 should be large enough to allow adequate time for pre-fetching the needed portions of packet N1+1 before they are accessed. It should additionally be no larger than needed to achieve this goal. Larger values could result in needed data being evicted from cache.

To help achieve the correct value of N1, embodiments of the present subject matter may consider the processor cache memory size and utilization. Additionally, the DCA activity may be restricted to select traffic such as high priority queues or TCP.

Embodiments of the present subject matter involve coordinating DCA requests with interrupt processing by a device driver. The interrupt coordination is achieved by synchronizing the DMA activity with the interrupt moderation and assertion timers. According to an embodiment of the present subject matter, a DCA flush timer is set relative to an interrupt assertion timer. This allows the device driver to program the flush timer so that the delay matches the platform and Operating System (OS) interrupt delay. For example, in operating systems that access the descriptors immediately, the flush timer can be set to a value prior to the interrupt assertion sufficient to allow the stored DCA transactions to complete. This flush timer value would have several dependencies such as bus bandwidth, packet rate, and interrupt moderation. An adaptive algorithm may be used to tune the flush timer.

For operating systems where the DCA transferred data is accessed in a deferred procedure call (DPC) rather than an Interrupt Service Routine (ISR), a DCA coordination timer can be set to a value subsequent to the interrupt assertion. This would allow the DCA transactions to occur after the interrupt assertion and prior to the DPC execution. The DCA coordination timer value may be an adaptively programmable value.

Other methods of improving a DCA flush may be used according to embodiments of the present subject matter when the device driver and controller are operating in polling mode. For example, a DCA flush timer may be set that is not relative to the interrupt assertion. Alternatively, a DCA flush threshold of packet, byte, or descriptor counts may be used.

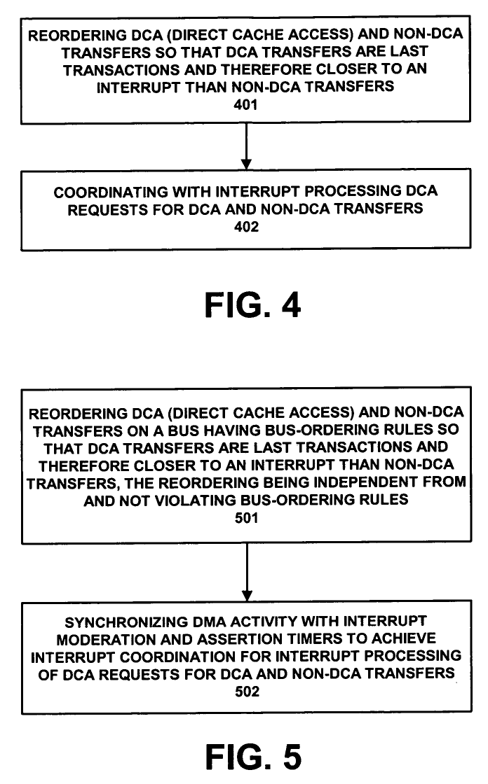

FIG. 4 is a flow diagram of a method for DMA according to an embodiment of the present subject matter. In 401, DCA and non-DCA transfers are reordered so that DCA transfers are last transactions and therefore closer to an interrupt than non-DCA transfers. In 402, DCA requests for DCA and non-DCA transfers are coordinated with interrupt processing.

FIG. 5 is a flow diagram of a method for DMA according to another embodiment of the present subject matter. In 501, DCA and non-DCA transfers are reordered on a bus having bus-ordering rules so that DCA transfers are last transactions and therefore closer to an interrupt than non-DCA transfers. The reordering is independent from and does not violate bus-ordering rules. In 502, DMA activity is synchronized with interrupt moderation and assertion timers to achieve interrupt coordination for interrupt processing of DCA requests for DCA and non-DCA transfers.

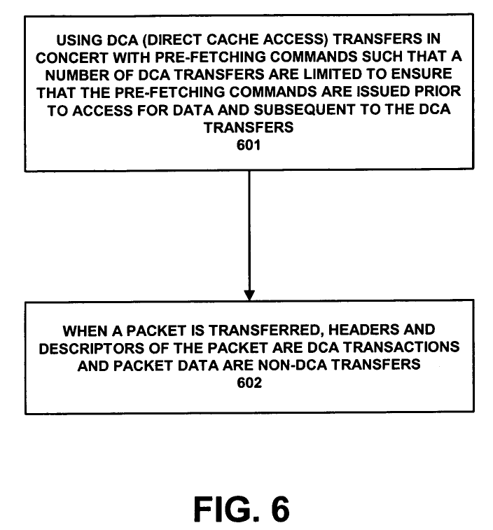

FIG. 6 is a flow diagram of a method for DMA according to another embodiment of the present subject matter. In 601, DCA transfers are used in concert with pre-fetching commands such that a number of DCA transfers are limited to ensure that the pre-fetching commands are issued prior to access for data and subsequent to the DCA transfers. In 602, when a packet is transferred, headers and descriptors of the packet are DCA transactions and packet data are non-DCA transfers.

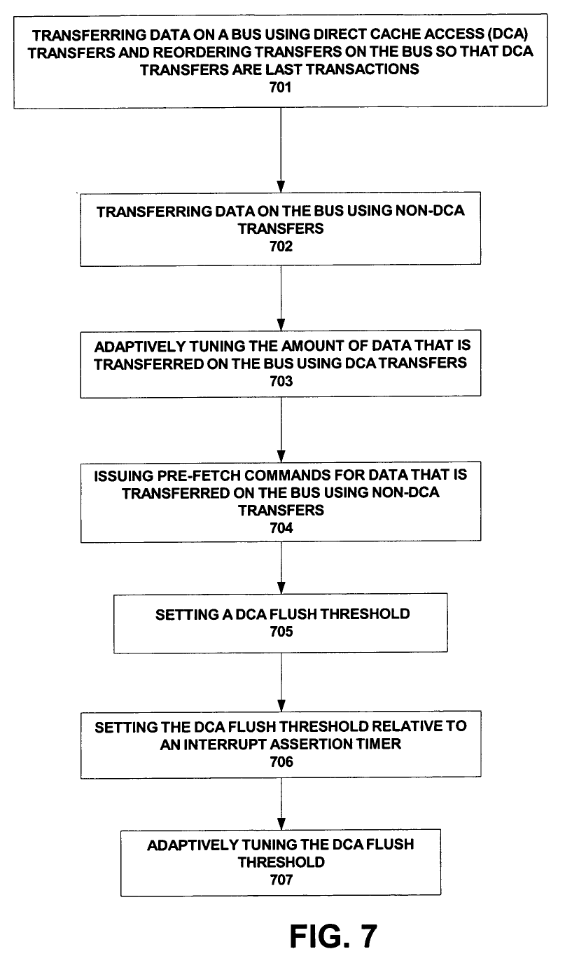

FIG. 7 is a flow diagram of a method for DMA according to another embodiment of the present subject matter. In 701, data is transferred on a bus using direct cache access (DCA) transfers and the transfers are reordered so that DCA transfers are last transactions. In 702, data is transferred on the bus using non-DCA transfers. In 703, the amount of data that is transferred on the bus using DCA transfers is adaptively tuned. In 704, pre-fetch commands are issued for data that is transferred on the bus using non-DCA transfers. In 705, a DCA flush threshold is set. In 706, the DCA flush threshold is set relative to an interrupt assertion timer. In 707, the DCA flush threshold is adaptively tuned.

Embodiments of the present subject matter can be applied with any bus master device. Embodiments of the present subject matter can be applied in high-speed network applications such as a 10 gigabit Ethernet or a wireless network. Embodiments of the present subject matter can be implemented with many types of operating systems. Embodiments of the present subject matter may also be implemented in other network applications, and other hardware.

Embodiments of the present subject matter have several advantages. Bus transactions are reordered such that DCA events are last, which includes reordering events between packets. DCA transactions may be synchronized with interrupt assertion. Embodiments of the present subject matter include an adaptively programmable timer or threshold, and this timer may or may not be relative to an interrupt assertion.

DCA may be used in concert with pre-fetching. DCA transactions may be limited to the number needed to ensure that pre-fetching commands may be adequately issued prior to access for data subsequent to the DCA transactions. DCA transactions may be limited based on the size of the processor's cache. DCA may be limited to select traffic or queues.

Embodiments of the present subject matter, along with the pre-fetching technique, utilize the strengths of each of DCA and pre-fetching. These embodiments of the present subject matter limit the number of packets for which DCA transactions need to be issued. The embodiments of the present subject matter select the most appropriate tool for a given situation.

The operations described herein are just exemplary. There may be many variations to these operations without departing from the spirit of the inventive subject matter. For instance, the operations may be performed in a differing order, or operations may be added, deleted, or modified.

Although exemplary implementations of the inventive subject matter have been depicted and described in detail herein, it will be apparent to those skilled in the relevant art that various modifications, additions, substitutions, and the like can be made without departing from the spirit of the inventive subject matter, and these are therefore considered to be within the scope of the inventive subject matter as defined in the following claims.

What is claimed is:

1. A method comprising:
using direct cache access (DCA) transfers in concert with pre-fetching commands such that a number of DCA transfers are limited to ensure that the pre-fetching commands are issued prior to access for data and subsequent to the DCA transfers.

2. The method according to claim 1, further comprising:
reordering DCA and non-DCA transfers so that DCA transfers are last transactions and therefore closer to an interrupt than non-DCA transfers; and
coordinating with interrupt processing requests for DCA and non-DCA transfers.

3. The method according to claim 2, wherein transfers occur on a bus having bus-ordering rules, and wherein the reordering is independent from and does not violate bus-ordering rules.

4. The method according to claim 1, wherein packets have headers and packet data, and wherein, when a packet is transferred, headers and descriptors are DCA transactions and packet data are non-DCA transfers.

5. The method according to claim 4, wherein packets are not accessed until the descriptors are transferred, so long as the descriptors remain a final transfer, and wherein an order of other transfers is changeable.

6. The method according to claim 4, wherein the method further comprises limiting DCA transfers to one of size of a cache of a processor and select traffic or queues.

7. The method according to claim 6, wherein, in operating systems that access the descriptors immediately, a timer is set to a value prior to an interrupt assertion to allow stored DCA transfers to complete.

8. The method according to claim 7, wherein the value is dependent on a plurality of dependencies.

9. The method according to claim 8, wherein the dependencies is at least one of a bus bandwidth, packet rate, and interrupt moderation.

10. The method according to claim 1, wherein, in operating systems where DCA transferred data is accessed in a deferred procedure call (DPC), the method further comprises setting a DCA coordination timer to a value subsequent to an interrupt assertion.

11. A method comprising:
transferring data on a bus using direct cache access (DCA) transfers; and
reordering transfers on the bus so that DCA transfers are last transactions.

12. The method according to claim 11, further comprising transferring data on the bus using non-DCA transfers.

13. The method according to claim 12, further comprising adaptively tuning the amount of data that is transferred on the bus using DCA transfers.

14. The method according to claim 12, further comprising issuing pre-fetch commands for data that is transferred on the bus using non-DCA transfers.

15. The method according to claim 11, further comprising setting a DCA flush threshold.

16. The method according to claim 15, further comprising setting the DCA flush threshold relative to an interrupt assertion timer.

17. The method according to claim 15, further comprising adaptively tuning the DCA flush threshold.

18. An apparatus comprising:
a bus; and
a reordering module operatively coupled to the bus, transfers on the bus being reordered so that direct cache access (DCA) transfers are last transactions.

19. The apparatus according to claim 18, wherein the bus is coupled to receive non-DCA transfers of data.

20. The apparatus according to claim 19, further comprising a processor coupled to the bus to adaptively tune the amount of data that is transferred on the bus using DCA transfers.

21. The apparatus according to claim 19, further comprising a processor coupled to the bus to issue pre-fetch commands for data that is transferred on the bus using non-DCA transfers.

22. The apparatus according to claim 18, further comprising a processor coupled to the bus to set a DCA flush threshold.

23. The apparatus according to claim 22 wherein the processor is coupled to a coordinating module operatively coupled to the bus to set the DCA flush threshold relative to an interrupt assertion timer.

24. The apparatus according to claim 22 wherein the processor is coupled to the bus to adaptively tune the DCA flush threshold.

25. A system comprising:
a bus having bus-ordering rules to transfer packets on the bus, the packets having headers and packet data;
a disk drive device having data, the disk drive device being operatively coupled to the bus, the data being transferred on the bus in the packets, and when a packet is transferred on the bus, the headers and descriptors being DCA transfers and the packet data being non-DCA transfers;
a reordering module operatively coupled to the bus, DCA and non-DCA transfers on the bus being reordered such that DCA transfers are last transactions and therefore closer to an interrupt than non-DCA transfers;
a coordinating module operatively coupled to the bus, requests for DCA and non-DCA transfers being coordinated with interrupt processing; and
an I/O device operatively coupled to the bus for at least receiving the packets.

26. The system according to claim 25, wherein the reordering is independent from and does not violate the bus-ordering rules.

27. The system according to claim 25, wherein the packets are not accessed until the descriptors are transferred, so long as the descriptors remain a final transfer, and wherein an order of other transfers is changeable.
